(19) United States
(12) Patent Application Publication
(10) Pub. No.: US 2010/0169228 A1
(43) Pub. Date: Jul. 1, 2010

(54) Integrated Negotiation Engine

(76) Inventors: Martina Rothley, Schwetzingen (DE); Carmen Blaum, Bodenheim (DE)

Correspondence Address: MINTZ, LEVIN, COHN, FERRIS, GLOVSKY & POPEO, P.C., ONE FINANCIAL CENTER, BOSTON, MA, 02111, US

(21) Appl. No.: 12/347,500

(22) Filed: Dec. 31, 2008

(51) Int. Cl. G06Q 30/00

(52) U.S. Cl. 705/80

(57) ABSTRACT

A negotiation system and method for producing a set of transaction terms for a transaction between a purchaser and a supplier is presented. The negotiation system includes a negotiation tool adapted to receive and store supplier data and transaction data from one or more data sources via a communications network. The negotiation system further includes a simulation tool in communication with the negotiation tool to receive selected supplier data and selected transaction data from the supplier data and transaction data stored by the negotiation tool. The simulation tool is further adapted to generate, from the selected supplier data and selected transaction data, one or more simulations of the transaction, and to generate an interactive graphical representation of selected simulations of the one or more simulations in a graphical user interface for being displayed to a user

### BACKGROUND

This disclosure relates generally to information processing systems, and more particularly to a negotiation system that processes and provides to a user pre-configured real-time negotiation content.

Effective negotiations between a purchaser and its vendors is very time consuming and information-intensive. But to be effective for the purchaser, the purchaser should have as much useful and pertinent information as possible, particularly as related to prices and conditions from various previous purchasing transactions.

Current business software does not adequately support price negotiations, and no tool currently exists for providing a purchaser with pre-configured, real-time negotiation content that gives the purchaser the useful and pertinent information needed to conduct effective purchasing negotiations.

### SUMMARY

In general, this document discusses a system and method for producing a set of transaction terms for a transaction between a purchaser and a supplier.

In one aspect, a negotiation system for producing a set of transaction terms for a transaction between a purchaser and a supplier includes a negotiation tool adapted to receive and store supplier data and transaction data from one or more data sources via a communications network. The negotiation system further includes a simulation tool in communication with the negotiation tool to receive selected supplier data and selected transaction data from the supplier data and transaction data stored by the negotiation tool. The simulation tool is further adapted to generate, from the selected supplier data and selected transaction data, one or more simulations of the transaction. The simulation tool is further adapted to generate an interactive graphical representation of selected simulations of the one or more simulations in a graphical user interface for being displayed to a user.

In another aspect, a computer-implemented method for producing a set of transaction terms for a transaction between a purchaser and a supplier is disclosed. The method includes the steps of receiving supplier data and transaction data from one or more data sources via a communications network, and storing the received supplier data and transaction data in a memory. The method further includes the steps of accessing selected supplier data and selected transaction data from the memory, generating one or more simulations of the transaction from the selected supplier data and selected transaction data, and generating an interactive graphical representation of selected simulations of the one or more simulations in a graphical user interface.

In yet another aspect, an article comprising tangibly embodied computer-readable media operable to cause data processing apparatus to perform operations for producing a set of transaction terms for a transaction between a purchaser and a supplier is disclosed. The operations include operations to receive supplier data and transaction data from one or more data sources via a communications network, and store the received supplier data and transaction data in a memory. The operations further include operations to access selected supplier data and selected transaction data from the memory, generate one or more simulations of the transaction from the selected supplier data and selected transaction data; and store the one or more simulations of the transaction in a second memory.

The details of one or more embodiments are set forth in the accompanying drawings and the description below. Other features and advantages will be apparent from the description and drawings, and from the claims.

### BRIEF DESCRIPTION OF THE DRAWINGS

These and other aspects will now be described in detail with reference to the following drawings.

FIG. 1 is a block diagram of an negotiation system.

FIG. 2 is a block diagram of an integrated negotiation engine.

FIG. 3 is a flowchart of a method for using a negotiation engine.

FIG. 4 shows a graphical representation of a pair of simulations of a transaction.

FIG. 5 shows a graphical user interface generated by a simulation tool.

Like reference symbols in the various drawings indicate like elements.

### DETAILED DESCRIPTION

This document describes an integrated negotiation system for producing a set of transaction terms for a transaction between a purchaser and a supplier. The negotiation system includes a negotiation engine that operates in both an online and offline mode. The negotiation engine includes a negotiation tool adapted to receive and store supplier data and transaction data from one or more data sources via a communications network. The negotiation engine further includes a simulation tool in communication with the negotiation tool to receive selected supplier data and selected transaction data from the supplier data and transaction data stored by the negotiation tool. The simulation tool is adapted to generate, from the selected supplier data and selected transaction data, one or more simulations of the transaction. The simulation tool is further adapted to generate an interactive graphical representation of selected simulations of the one or more simulations in a graphical user interface for being displayed to a user.

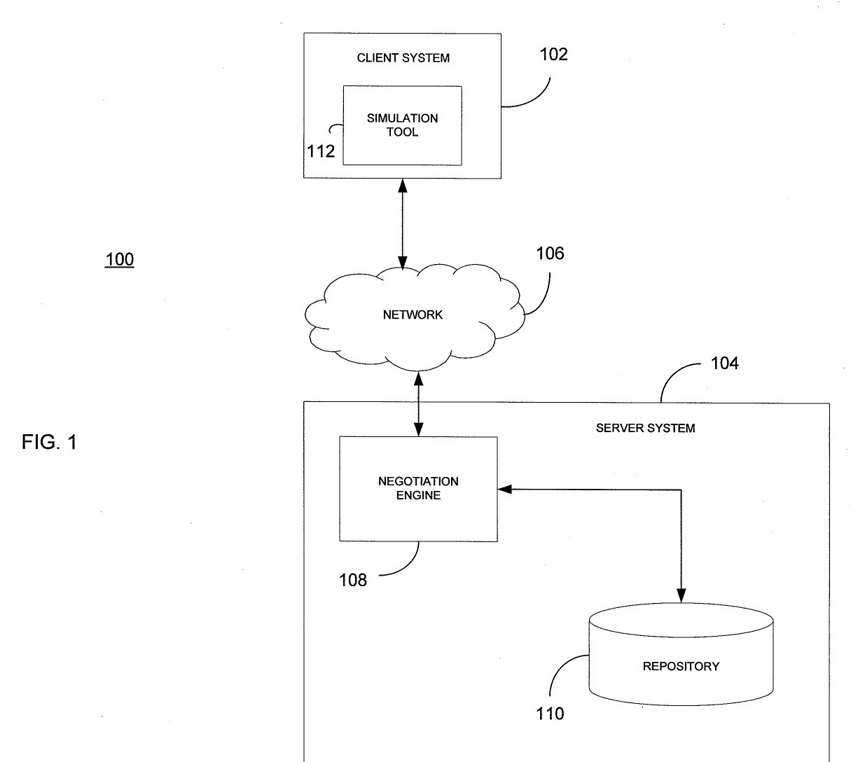

FIG. 1 depicts an exemplary system 100 having a negotiation engine 108 for conducting purchaser negotiations with one or more product or service suppliers. The system 100 includes a client system 102 coupled to a server system 104 through a network 106 (e.g., the Internet or an intranet). The client system 102 and server system 104 may be implemented as one or more processors, such as a computer. The client system 102 is preferably a computer, such as a personal computer (PC) workstation, laptop computer, or handheld computing device such as a smart phone, personal digital assistant (PDA), etc. The client system 102 may be configured for online (i.e. communication with server system 104) and offline (i.e. standalone) operation.

The server system 104 includes a repository 110. The repository 110 can be organized as a database and implemented as a data warehouse, and include data structured as a snowflake schema, datacube, a star schema, or any other data structure. The repository 110 includes structured data, such as data types, business objects, services and the like. The term “data type” refers to a data definition and its structure including at least one of data and related metadata, while the phrase “business object” and “service” refers to an object and its method used in connection with a business process or a task.

The repository 110 stores data, from a number of internal or external data sources, that provides general data about the one or more suppliers and one or more transactions related to the suppliers. The general data may include supplier data such as a supplier address, and associated business data such as industry sector, size of the supplier, general market data, etc. The general data may also include a supplier evaluation score data based on a supplier evaluation score or a history of supplier evaluation scores (i.e. 2 to 5 years or more), which score may be based on qualitative and quantitative scoring factors such as how well the supplier performed in past contracts, price reliability, etc. The scores can be generated from business software internal to the server system 104, or uploaded from other server systems via the network 106.

The general data may also include transaction data such as spend data related to the product or categories currently under negotiation, and may include historical data such as the overall amount spent over a period of time (i.e. 2 to 5 years or more), total purchase order numbers, identification of products, categories, and associated quantities. The spend data can further include quantities procured over the period of time.

The repository 110 may also include other transaction data, including prices and conditions over the period of time, with price origin that includes an internal price (i.e. standard price or average price of material evaluation) and/or an external price (i.e. from a quote, contract, catalog, list price, single purchase order, etc.). Other data may include a bonus or premium given to a supplier depending on total supplier spend, payment terms over a period of time, Incoterms (freight) and other delivery conditions, influence of currency exchange rates over a period of time, and opportunity costs or other political factor data, such as a surcharge realized for a requirement to use a particular supplier.

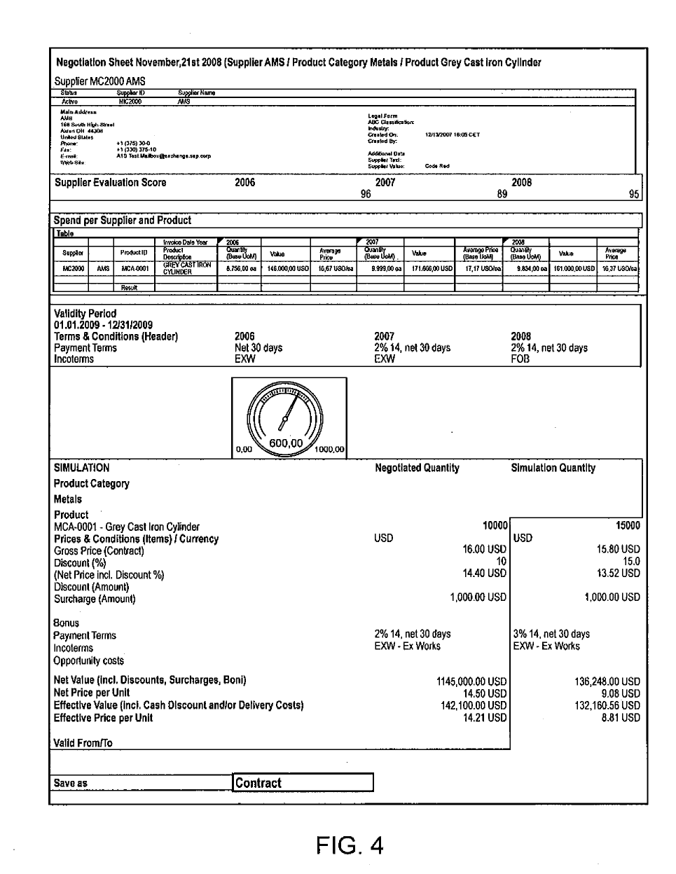

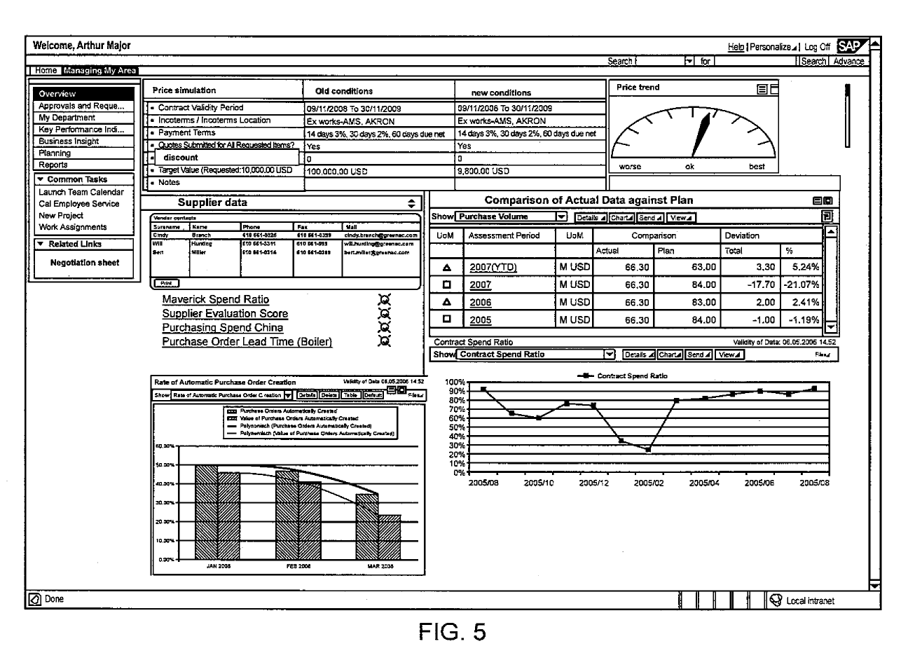

Data from the repository 110 is processed by a negotiation engine 108 to generate a graphical user interface (GUI) for a simulation tool 112. The negotiation engine 108 is preferably implemented as one or more software code modules executed by a machine or a computer such as the server system 104 or client system 102. The simulation tool 112 is also preferably implemented as one or more software code modules executed by a machine or a computer such as the client system 102, and includes a graphics generator for generating the graphical user interface. The simulation tool 102 displays the data from the repository 110 in a format that can be quickly and efficiently viewed by a user. In some implementations, the negotiation engine 108 and simulation tool 112 are installed and execute on the client system 102. Example graphical user interfaces generated by the simulation tool 102 are shown in FIGS. 4-5.

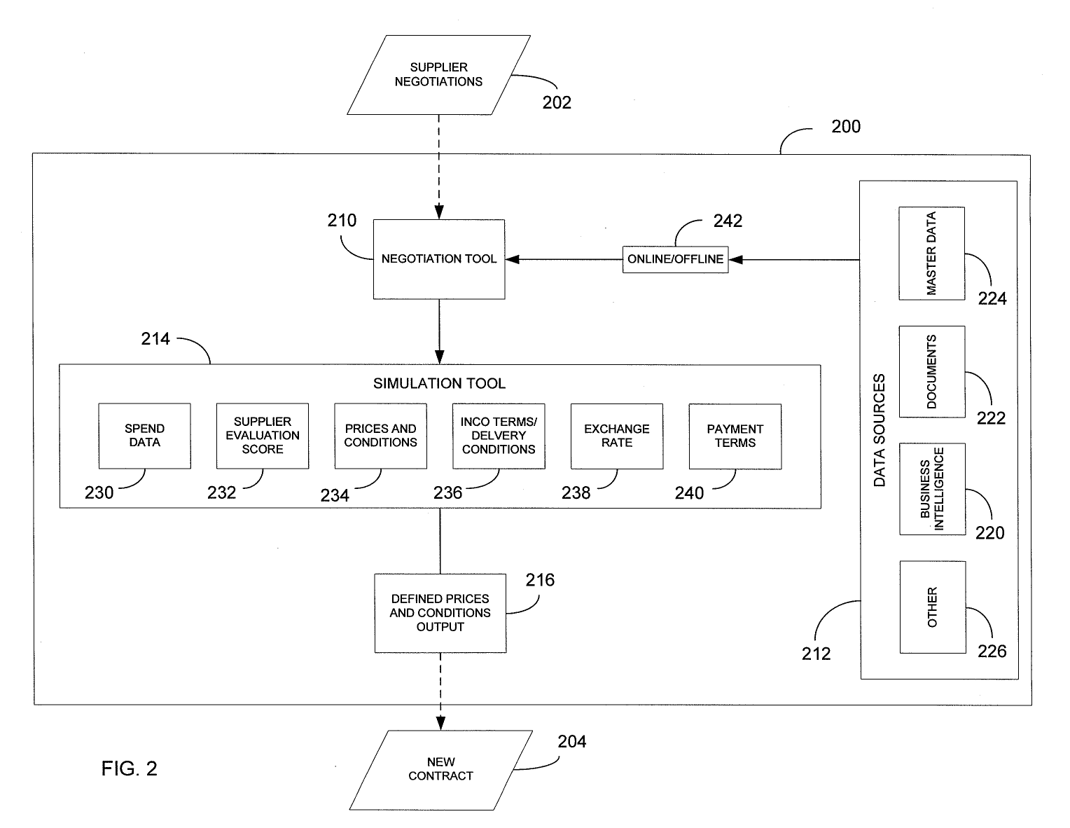

FIG. 2 is a block diagram of an integrated negotiation engine 200 that assists a participant to supplier negotiations 202 to produce a new contract 204 for a transaction. The new contract 204 can be a supply contract, quote or response to a request for quote, purchase order, or other transaction between a supplier and a purchaser. The negotiation engine 200 includes a negotiation tool 210 that uses and processes supplier data and transaction data from a variety of data sources 212, and provides the processed data to a simulation tool 214, which in turn generates a graphical representation of key data, terms and conditions in a defined prices and conditions output 216 related to the supplier negotiations 202.

The defined prices and conditions output 216 can be in the form of a display on a computer monitor or laptop display, for example, or may be a document. Further, the document can be electronically rendered in the display, or may be produced as a hardcopy or printed out. In some implementations, the simulation tool 214 generates a display as shown in FIGS. 4 and 5, which includes the defined pricing and conditions output 216. The negotiation engine 200 is preferably implemented on a computing platform used by the purchaser, and can be operated both online and offline, i.e. connection via online/offline module 242 to the data sources 212. In an online mode, the negotiation tool 210 can continually receive data from the one or more data sources. In an offline mode, the negotiation tool 210 and simulation tool 214 relies on local input for adjusting any of a number of variables under consideration for the supplier negotiations 202. In one example, a user of the negotiation tool 210 uploads all the needed data from the data sources 212 in the online mode, and then operates the negotiation tool 210 and simulation tool 214 while in offline mode and in negotiations.

The data sources 212 includes business intelligence 220, which may be any system, database or application that aggregates, integrates, analyzes and interprets business information, from local or external sources. The data sources 212 further include documents in any of a number of document repositories, as well as master data 224. The data sources 212 may also include other sources 226.

The negotiation tool 210 selects or receives data from the data sources 212, and provides the selected data to the simulation tool 214, which in turn generates a number of simulation modules that simulate a number of variables under consideration. Each simulation module can be generated in the form of a document or graphical, for display in a graphical user interface. The simulation modules include spend data 230, which can be an amount spent for a period of time (i.e. three years) for a product or product category that is currently the subject of the supplier negations. The spend data 230 can include, without limitation, an amount spent for a period of time on a particular product, on a particular supplier, for a product category, for a supplier category, etc. The simulation tool 214 also uses a supplier evaluation score 232 within a simulation to determine the best supply source, which may be a score of any qualitative or quantitative factors such as how well a particular supplier has performed, reliability (price, supplier performance), and other factors.

The simulation tool 214 also generates prices and conditions 234 related to the supplier negations 202, and which can be manipulated in real-time by the simulation tool 214 to provide any number of simulated scenarios for the defined prices and conditions output 216. The prices and conditions 234 may include, without limitation, internal price data such as standard price or average price of material evaluation, and external prices based on quotes, contracts, catalogs, list prices, single purchase orders, etc. The simulation tool 214 also may use simulated incoterms/delivery conditions 236, preferably based on a past period of time that provides a baseline of anticipated or present incoterms and delivery conditions. Other simulation modules used and generated by the simulation tool 214 include exchange rate 238 to simulate and account for currency exchange rate fluctuations for foreign suppliers, and payment terms 240, to simulate and account for a past period of time (i.e. three years) of terms.

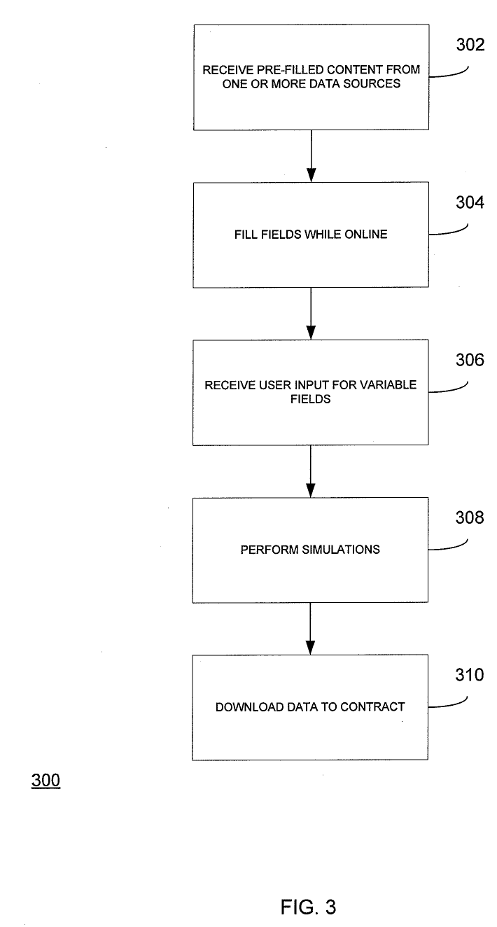

FIG. 3 is a flowchart 300 of operations of an integrated negotiation engine, as substantially described above. At 302, pre-filled content is received by the negotiation engine from one or more data sources. The pre-filled content includes address data, analytical data, historical data, etc., related to a supplier of goods or services that are currently under negotiation. At 304, the negotiation engine receives data for filling other fields of negotiation variables, preferably while online. The data can include price, conditions, exchange rate, delivery terms, and supplier evaluation scores. At 306, the negotiation engine receives user input for any necessary variable fields, related to variables of the negotiation, such as price and conditions, etc. The data can be also be uploaded from past contracts or other documents.

At 308, the negotiation engine uses the received data to perform one or more simulations on the negotiation. For example, the negotiation engine may use historical data to change the number of products being purchased to simulate whether a discount may be realized. At 310, the negotiation engine downloads data into a contract, i.e. inserts selected terms and conditions into relevant fields of a contract, or updates an ERP system automatically with negotiated prices, conditions, etc.

Accordingly, the negotiation engine provides a flexible tool to support a user in supplier negotiations, as well as a graphical user interface for efficient representation of data and the dynamic simulations applied to the data. The negotiation tool reduces preparation time in accumulating relevant data and useful historical information related to a negotiation, and reduces wrap-up times of the outcome of such negotiations, as negotiated prices and conditions are automatically updated into other business software systems, such as ERP systems.

FIG. 4 illustrates a defined prices and conditions output, which can be rendered in a graphical user interface or produced as a document. FIG. 5 illustrates an exemplary simulation tool interface in which pricing, conditions, and other data can be altered in real-time to evaluate the outcome or result of such alterations. The simulation tool interface can also graphically display historical data, in the form of charts, graphs, or other graphical objects.

Some or all of the functional operations described in this specification can be implemented in digital electronic circuitry, or in computer software, firmware, or hardware, including the structures disclosed in this specification and their structural equivalents, or in combinations of them. Embodiments of the invention can be implemented as one or more computer program products, i.e., one or more modules of computer program instructions encoded on a computer readable medium, e.g., a machine readable storage device, a machine readable storage medium, a memory device, or a machine-readable propagated signal, for execution by, or to control the operation of, data processing apparatus.

The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of them. A propagated signal is an artificially generated signal, e.g., a machine-generated electrical, optical, or electromagnetic signal, that is generated to encode information for transmission to suitable receiver apparatus.

A computer program (also referred to as a program, software, an application, a software application, a script, or code) can be written in any form of programming language, including compiled or interpreted languages, and it can be deployed in any form, including as a stand alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for executing instructions and one or more memory devices for storing instructions and data. Generally, a computer will also include, or be operatively coupled to, a communication interface to receive data from or transfer data to, or both, one or more mass storage devices for storing data, e.g., magnetic, magneto optical disks, or optical disks.

Moreover, a computer can be embedded in another device, e.g., a mobile telephone, a personal digital assistant (PDA), a mobile audio player, a Global Positioning System (GPS) receiver, to name just a few. Information carriers suitable for embodying computer program instructions and data include all forms of non volatile memory, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, embodiments of the invention can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Embodiments of the invention can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the invention, or any combination of such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

Certain features which, for clarity, are described in this specification in the context of separate embodiments, may also be provided in combination in a single embodiment. Conversely, various features which, for brevity, are described in the context of a single embodiment, may also be provided in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Particular embodiments of the invention have been described. Other embodiments are within the scope of the following claims. For example, the steps recited in the claims can be performed in a different order and still achieve desirable results. In addition, embodiments of the invention are not limited to database architectures that are relational; for example, the invention can be implemented to provide indexing and archiving methods and systems for databases built on models other than the relational model, e.g., navigational databases or object oriented databases, and for databases having records with complex attribute structures, e.g., object oriented programming objects or markup language documents. The processes described may be implemented by applications specifically performing archiving and retrieval functions or embedded within other applications.

What is claimed is:

1. A negotiation system for producing a set of transaction terms for a transaction between a purchaser and a supplier, the negotiation system comprising:
a negotiation tool adapted to receive and store supplier data and transaction data from one or more data sources via a communications network; and
a simulation tool in communication with the negotiation tool to receive selected supplier data and selected transaction data from the supplier data and transaction data stored by the negotiation tool, and adapted to generate, from the selected supplier data and selected transaction data, one or more simulations of the transaction, the simulation tool further adapted to generate an interactive graphical representation of selected simulations of the one or more simulations in a graphical user interface for being displayed to a user.

2. The negotiation system in accordance with claim 1, wherein the supplier data includes a supplier address and historical business data related to the supplier.

3. The negotiation system in accordance with claim 1, wherein the interactive graphical representation is selected from a group of interactive graphical objects that consists of: a table, a bar graph, a chart, and a graphically represented device.

4. The negotiation system in accordance with claim 1, wherein the negotiation tool and the simulation tool are adapted to operate in an online mode in which the negotiation tool is connected to the communications network, and in an offline mode in which the negotiation tool is disconnected from the communications network.

5. The negotiation system in accordance with claim 1, wherein the simulation tool is further adapted to download data from the selected simulations into a transaction document.

6. The negotiation system in accordance with claim 1, wherein the transaction data includes prices and conditions related to the transaction.

7. The negotiation system in accordance with claim 1, wherein the transaction data includes payment terms and freight or delivery terms.

8. A computer-implemented method for producing a set of transaction terms for a transaction between a purchaser and a supplier, the method comprising:
receiving supplier data and transaction data from one or more data sources via a communications network;
storing the received supplier data and transaction data in a memory;
accessing selected supplier data and selected transaction data from the memory;
generating one or more simulations of the transaction from the selected supplier data and selected transaction data; and
generating an interactive graphical representation of selected simulations of the one or more simulations in a graphical user interface.

9. The method in accordance with claim 8, wherein the supplier data includes a supplier address and historical business data related to the supplier.

10. The method in accordance with claim 8, wherein the interactive graphical representation is selected from a group of interactive graphical objects that consists of: a table, a bar graph, a chart, and a graphically represented device.

11. The method in accordance with claim 8, wherein the negotiation tool and the simulation tool are adapted to operate in an online mode in which the negotiation tool is connected to the communications network, and in an offline mode in which the negotiation tool is disconnected from the communications network.

12. The method in accordance with claim 8, further comprising downloading data from the selected simulations into a transaction document.

13. The method in accordance with claim 8, wherein the transaction data includes prices and conditions related to the transaction.

14. The method in accordance with claim 8, wherein the transaction data includes payment terms and freight or delivery terms.

15. The method in accordance with claim 8, further comprising storing the one or more simulations of the transaction in the memory.

16. An article comprising tangibly embodied computer-readable media operable to cause data processing apparatus to perform operations for producing a set of transaction terms for a transaction between a purchaser and a supplier, the operations comprising:
receive supplier data and transaction data from one or more data sources via a communications network;
store the received supplier data and transaction data in a memory;
access selected supplier data and selected transaction data from the memory;
generate one or more simulations of the transaction from the selected supplier data and selected transaction data; and
store the one or more simulations of the transaction in a second memory.

17. The article in accordance with claim 16, further comprising operations to cause the data processing apparatus to generate an interactive graphical representation of selected simulations of the one or more simulations in a graphical user interface.

18. The article in accordance with claim 16, further comprising operations to cause the data processing apparatus to download data from the selected simulations into a transaction document.

19. The article in accordance with claim 16, wherein the supplier data includes a supplier address and historical business data related to the supplier.

20. The article in accordance with claim 16, wherein the transaction data includes prices and conditions related to the transaction.
